(19) United States
(12) Patent Application Publication
(10) Pub. No.: US 2021/0143493 A1
(43) Pub. Date: May 13, 2021

(54) TEMPERATURE REGULATING DEVICE AND DEVICE ARRANGEMENT IN A TEMPERATURE REGULATING SYSTEM

(71) Applicant: NIDEC GPM GmbH, Auengrund OT Merbelsrod (DE)

(72) Inventor: Jens HOFFMANN, Schwarzbach (DE)

(73) Assignee: NIDEC GPM GmbH, Auengrund OT Merbelsrod (DE)

(21) Appl. No.: 17/044,739

(22) PCT Filed: Apr. 2, 2019
(86) PCT No.: PCT/EP2019/058223

§ 371 Date: Oct. 1, 2020

(30) Foreign Application Priority Data
Apr. 4, 2018 (DE) 10 2018 107 913.3

(51) Int. Cl. H01M 10/63; H01M 10/48; H01M 10/613; H01M 10/625; H01M 10/6556; H01M 10/6568; H01M 10/6571; H01M 10/615; B60L 50/60; B60L 58/26; B60L 58/27

(52) U.S. Cl. CPC H01M 10/63; H01M 10/486; H01M 10/613; H01M 10/625; H01M 10/6556; H01M 2220/20; H01M 10/6571; H01M 10/615; B60L 50/60; B60L 58/26; B60L 58/27; H01M 10/6568

(57) ABSTRACT

A temperature regulating device for regulating the temperature of a drive battery of an electric drive in a vehicle by means of a temperature regulating circuit. The temperature regulating circuit has a battery flow-through section in thermal contact with the drive battery; a cooling flow-through section in thermal contact with an ambient heat exchanger; and piping sections for connecting the temperature regulating circuit and the temperature regulating device. The temperature regulating device includes: an electric pump assembly with a pump housing for circulating a liquid heat transfer medium; electric heating means for heating the heat transfer medium; and temperature regulation control means having a pump control section; and a heating control section; A heating flow-through section for the temperature regulating circuit is in thermal contact with the electric heating means, and is arranged inside the pump housing.

### RELATED APPLICATIONS

This application is a National Phase entry of PCT Application No. PCT/EP2019/058223 filed Apr. 2, 2019, which application claims the benefit of priority to German Application No. 10 2018 107 913.3, filed Apr. 4, 2018, the entire disclosures of which are incorporated herein by reference.

### FIELD OF THE INVENTION

The present invention relates to a device arrangement in a temperature regulating system for a drive battery in a vehicle comprising a cost-optimized and installation-optimized structure.

### BACKGROUND OF THE INVENTION

Electric vehicles and hybrid vehicles which can be driven completely or at least partially by battery electricity use drive batteries which provide high levels of electrical power. Furthermore, in addition to the driving operation high levels of electrical power occur during the procedure of charging the drive battery. By means of an internal resistance which opposes charge transfers in each battery cell, all electrical power loads are associated with a power loss in the form of heat generation. Thermal management of electrified vehicles involves the dissipation of this heat generation in order to avoid overheating damage and temperature fluctuations amongst individual battery cells in a high-capacity battery in favour of a longer service life.

Thermal management for vehicles driven by battery electricity is also known and addresses not only the problem of heat dissipation but also the problem of heat supply to the drive battery after a cold start. At lower temperatures, the battery cells comprise a higher internal resistance which results in a corresponding voltage drop. Therefore, safe operation is not guaranteed below a permissible temperature range. The thermal management brings the temperature of the battery cells to an ideal operating temperature range and then controls a temperature regulation in order to maintain the operating temperature range.

The prior art discloses various system designs for regulating the temperature of a battery which, in terms of such thermal management, actively influence the battery temperature.

For instance DE 10 2007 045 183 A1 discloses a battery apparatus comprising a battery and at least one heating and/or cooling apparatus which regulates the temperature of the battery, wherein the battery is immersed in a heating and/or cooling medium and the battery is arranged in an enclosure receiving the heating and/or cooling medium. A thermostat controller monitors a temperature in the enclosure.

DE 10 2007 045 182 A1 describes air conditioning of a vehicle battery in a hybrid vehicle, wherein a circuit which runs past the vehicle battery can be heated by means of waste heat of an internal combustion engine or by means of a heating element.

DE 102 02 807 A1 discloses a system for regulating the temperature of high-capacity secondary batteries for vehicle applications. For heating or cooling purposes, the cells of the battery which are mounted in a closed housing are provided with channels, through which a heat-transporting medium flows. The heat-transporting medium is directed via a piping system to a heating/cooling apparatus arranged outside the battery housing and having a Peltier element. Circulation can be effected by means of a pump or via convection. In order to control the heating or cooling power, a regulator is provided which activates the heating/cooling apparatus and any pumps or fans possibly present in dependence upon the temperature of the cells measured via a temperature sensor.

From another technical application in the field of water-carrying domestic appliances, such as a dishwasher, WO 2014/198427 A1 and DE 10 2012 110 304 A1 describe a heating pump comprising a heating element.

Said systems for regulating the temperature of a battery comprise an extensive structure and a large number of individual parts.

A pump of such systems is typically controlled by means of a central control unit of a vehicle in dependence upon different operating parameters which are transmitted to the central control unit. Depending upon the number of parameters to be detected or the sensors required for this purpose and the consumers to be controlled, a correspondingly high number of signal lines and electrical lines to the central control unit, to the sensors and to the consumers is required in a closed loop. Therefore, the installation of a temperature regulating system of a drive battery is associated not only with the installation of pipings for the liquid heat transfer medium but also with considerable outlay relating to the electrical installation between the system components and to the central control unit in the vehicle.

Therefore, there is room for rationalization in the structure of known temperature regulating systems.

### SUMMARY OF THE INVENTION

The object of the invention is to provide a temperature regulating system of a drive battery which requires a small amount of assembly outlay in the vehicle and ensures a high level of operating reliability in a corrosive environment.

The temperature regulating device in accordance with the invention is characterized in particular in that it includes: an electric pump assembly with a pump housing for circulating a liquid heat transfer medium; electric heating means for heating the heat transfer medium; and temperature regulation control means having: a pump control section configured to control a pumping power; and a heating control section configured to control a heating power; wherein a heating flow-through section for the temperature regulating circuit, which is in thermal contact with the electric heating means, is arranged inside the pump housing.

The inventive device arrangement in a temperature regulating system is characterized accordingly in that a pump housing of a pump assembly includes a temperature regulation control means having: a pump control section configured to control a pumping power; and a heating control section configured to control a heating power; and a heating flow-through section of a temperature regulating circuit, which is in thermal contact with electrical heating means, is arranged inside the pump housing.

Therefore, the invention for the first time provides, for the purpose of regulating the temperature of a drive battery, the integration of heating of the heat transfer medium and a dedicated control combination of heating power and pumping power in the structure of a pump housing which are in a thermal operative relationship with a temperature progression of the drive battery.

As a result, the invention comprises, in comparison with said conventional systems, fewer system components and a reduced number of electrical lines for controlling the system components, in particular to an external unit such as a central control unit of a vehicle. Separate wiring with large line cross-sections for an electrical power supply to the pump drive and the heating means as well as separate wiring for communications interfaces between said interfaces and an external unit are omitted. Furthermore, the remaining wiring runs internally in a system component.

In the case of the invention, only one power supply line and optionally one communications line to an externally arranged unit are required. The omission of the lines and plug-in connections simplifies the structure and reduces the production costs of the temperature regulating system as well as the installation costs when installing same into a vehicle.

Furthermore, the susceptibility to failure of the temperature regulating system can be improved because in a mobile application, in particular with exposure to weathering influences and thrown-up grit or salt, it is possible to save on separate corrosion-sensitive plug-in connections and/or outlet seals with respect to the wiring of a pump and a heating section of the temperature regulating circuit as well as at least one external unit.

Furthermore, in the case of a central control unit of a vehicle, program routines on said control unit for regulating the individual devices in the temperature regulating system can be omitted. As a result, data processing load of the central control unit can be reduced. Therefore, either a central control unit having a lower data processing capacity can be used at correspondingly lower costs or the data processing power which is not required can be made available for control tasks of other peripheral devices or for the benefit of computing power.

It also becomes possible to provide a dedicated control characteristic from the outset which is optimised to the operating parameters of the implemented device combination of pump type and heating element type. Therefore, a corresponding pump in the supplied condition already provides an intrinsically coordinated, decentralised system for simpler integration in the vehicle control and in the vehicle.

Furthermore, a housing for a central control device of the temperature regulating system is not provided and installed.

In addition, a separate apparatus of the heating section for the heat transfer medium, including a housing, a receiver for heating means and a heat exchanger or suitable flow guidance, is not provided and installed.

Advantageous developments of the inventive temperature regulating device and the device arrangement in a temperature regulating system are described in the dependent claims.

According to one aspect of the invention, the temperature regulation control means can be configured to control the pumping power and the heating power depending on at least one of a temperature of the drive battery detected by a battery temperature sensor and a temperature of the heat transfer medium detected inside the temperature regulating circuit.

Therefore, an integrated regulating path for temperature-controlled control of the circulation and the heating of the heat transfer medium within the temperature regulating device or a system component of the temperature regulating system can be achieved.

According to one aspect of the invention, an inlet temperature sensor for detecting the temperature of the heat transfer medium inside a flowed-through section of the pump housing can be arranged upstream of the heating means.

Therefore, an integrated apparatus can be provided which allows the temperature regulation control means to make an inference as to a heat input of the heating means and the battery at an initial temperature of the heat transfer medium. Furthermore, wiring to an external temperature sensor can be omitted.

According to one aspect of the invention, an outlet temperature sensor for detecting the temperature of the heat transfer medium inside a flowed-through section of the pump housing can be arranged downstream of the heating means.

Therefore, an integrated apparatus can be provided which allows the temperature regulation control means to make an inference as to the resulting heat supply to the battery which results from the set power of the pump and the set power of the heating means. Furthermore, wiring to an external temperature sensor can be omitted.

According to one aspect of the invention, a connector can be arranged extending out of the pump housing, which provides a common interface for control sections of the temperature regulation control means to at least one of a central control unit of the vehicle and additional temperature sensors.

Therefore, the provision of wiring for separate communications interfaces of temperature sensors for the drive battery, the temperature regulating circuit, the surrounding area or similar devices in the system to an external control unit can be omitted.

According to one aspect of the invention, the cooling flow-through section can additionally comprise an electric fan for assisting the ambient heat exchanger, and the temperature regulation control means can include a cooling control section configured to control a fan power.

Therefore, the control of a further device can be integrated in the system, whereby the provision of a separate control device or cabling for a separate communications interface to an external control unit can be omitted.

According to one aspect of the invention, the temperature regulating circuit can additionally comprise a switchable bypass flow-through section for bypassing the cooling flow-through section, and the temperature regulation control means can include a bypass control section configured to switch the temperature regulating circuit between the cooling flow-through section and the bypass flow-through section.

Therefore, the control of a further device can be integrated in the system, whereby the provision of a separate control device or cabling for a separate communications interface to an external control unit can be omitted.

According to one aspect of the invention, the heating flow-through section can be formed by a pump chamber of a centrifugal pump type.

The pump chamber provides a convective region which promotes heat transfer to the mass flow of the heat transfer medium.

### BRIEF DESCRIPTION OF THE DRAWINGS

The invention will be explained in detail hereinafter with the aid of an exemplified embodiment and with reference to a drawing.

FIG. 1 is a block diagram of a temperature regulating system and the temperature regulating device included therein according to one embodiment of the invention.

Alternative embodiments can differ e.g. in terms of fewer, more or differently arranged temperature sensors than in the embodiment described hereinafter.

### DETAILED DESCRIPTION OF THE DRAWINGS

FIG. 1 shows a temperature regulating system 10 having a temperature regulating device 1 for regulating the temperature of a drive battery 2 by means of a liquid heat transfer medium which circulates in lines of a temperature regulating circuit 3. A pump assembly 13 of the temperature regulating device 1 is received in a pump housing 11 which at the same time forms a housing of the temperature regulating device 1. The heat transfer medium flows in the temperature regulating circuit 3 selectively through a cooling flow-through section 34 or a bypass flow-through section 36 and a battery flow-through section 32 before it subsequently returns to the pump assembly 13. The pump housing 11 serves at the same time as a heating flow-through section 35 which can be selectively activated.

The battery flow-through section 32 establishes thermal contact between the passing mass flow of the heat transfer medium and the drive battery 2 in order to dissipate waste heat of the drive battery 2 or to heat the drive battery 2. In order to establish the thermal contact, different known types of heat exchangers can be provided which enlarge a surface for the transfer of heat from the drive battery 2 to the battery flow-through section 32. In the embodiment, the battery flow-through section 32 is formed by parallel-extending, planar or meandering flow-through paths which are in contact with a thermal pool of a further heat transfer medium which surrounds the drive battery 2 in the form of a cooling jacket. The battery flow-through section 32 can likewise be connected to such a pool or cooling jacket and can form a flow-through path therethrough. Furthermore, the battery flow-through section 32 can be merely in surface contact with battery cells of the drive battery 2.

The cooling flow-through section 34 is in thermal contact with an ambient heat exchanger 4. The ambient heat exchanger 4 can be in particular a radiator which provides, by means of a lamellar surface structure, an enlarged surface for the transfer of heat from the mass flow of the heat transfer medium to the atmosphere surrounding the system, i.e. ambient air or a relative wind of the vehicle. In order to be able to influence and increase convection of the ambient air to the ambient heat exchanger 4, the temperature regulating system 10 further comprises an electric fan 44 which draws in ambient air and allows ambient air to flow out in a directed manner to the ambient heat exchanger 4.

If the heat transfer medium is not to be cooled, the heat transfer medium can flow by means of switching valves through a parallel-connected bypass flow-through section 36 which bypasses the cooling flow-through section 34. Furthermore, if the heat transfer medium is to be heated in order to heat the battery, the heating flow-through section 35 is activated in the pump assembly 13, in that the heating means 15 which is integrated in the pump housing 11 is supplied with electrical power.

The pump assembly 13 is of the type of centrifugal pump, not illustrated, having a radial impeller. The heating means 15 is arranged in a pump chamber and is thus in thermal contact with the conveying flow of the heat transfer medium. The heating means 15 comprises a plurality of PTC heating elements which are arranged in a region of a radially limiting chamber wall. In comparison with other flowed-through housing sections of the pump housing 11, such as a pump inlet or a pump outlet, the pump chamber provides a larger surface for the transfer of heat from the heating means 15 to the heat transfer medium. Furthermore, in the case of centrifugal pumps the greatest convection occurs in the pump housing 11 in the peripheral region of the pump chamber, whereby a transfer of heat from the heating means 15 to the heat transfer medium is additionally increased.

Instead of fitting the pump chamber out with a standard type of PTC heating elements which are arranged distributed over the peripheral region, it is likewise possible to use curved, area PTC heating elements or a cylindrical PTC heating element, the arrangement of which surrounds the pump chamber or which themselves form a chamber wall of the pump chamber. In this case, the entire periphery of the pump chamber can be used for the transfer of heat from the PTC element to the heat transfer medium.

In addition to the pump assembly 13 and the heating means 15, the pump housing 11 likewise comprises a temperature regulation control means 16 which controls an electrical power supply to an electrical drive of the pump assembly 13 and to the heating means 15. Furthermore, the temperature regulation control means 16 controls a power supply to an electrical drive of the fan 44 at the ambient heat exchanger 4 as well as actuators for switching the valves which guide the temperature regulating circuit 3 through the cooling flow-through section 34 or the bypass flow-through section 36.

The temperature regulation control means 16 comprises different control sections, in particular a pump control section, a heating control section, a fan control section and a bypass control section. Each control section performs a control routine of a control program and has access to integrated circuits or electronic regulators, which output control values with respect to measured signals, such as a temperature or a rotational speed of the pump, and has access to a power circuit for setting an electrical power supply to the respective consumer of the temperature regulating system 10 corresponding to the control variable.

The temperature regulation control means 16 is received in a receiving section, not illustrated, of the pump housing 11 which is spaced apart from or thermally insulated with respect to the heating means 15. The receiving section preferably comprises a heat bridge between the temperature regulation control means 16 and the heat transfer medium, e.g. a metallic housing wall on a flowed-through section of the pump housing 11, such as the pump inlet, in order to permit a transfer of heat from electric power loss of the power circuit to the mass flow of the heat transfer medium.

Furthermore, the temperature regulating device 1 or the temperature regulation control means 16 contained therein comprises a connector, e.g. a plug or a line, as an interface 17 for exchanging data with a central control unit of the vehicle. Via this data connection, the temperature regulation control means 16 can receive superordinate commands of the central control unit and information relating to operating conditions of the vehicle, such as a driving condition, surrounding area status or the like, or can communicate information relating to operating conditions of the temperature regulating system 10 to the central control unit.

Examples of control procedures of the temperature regulation control means 16 in the temperature regulating system 10 will be explained hereinafter.

At ambient temperatures below e.g. 10° C., in particular under 0° C., an internal resistance of battery cells can greatly impair a charging movement of large currents. Therefore, at corresponding external temperatures, during a cold start of the vehicle, the temperature regulating system 10 performs a heating procedure of the heat transfer medium in order to bring the drive battery 2 more rapidly to an optimum operating temperature range. For this purpose, the heating means 15 is supplied with electrical power in order to provide the activatable heating flow-through section 35 in the temperature regulating circuit 3 and the valves are activated such that the temperature regulating circuit 3 bypasses the cooling flow-through section 34 via the bypass flow-through section 36. The heat transfer medium which is heated by the heating means 15 circulates through the battery flow-through section 32 and outputs heat to the drive battery 2. The heating procedure is performed until the battery cells of the drive battery 2 have reached a lower threshold value of the optimum operating temperature range of e.g. 18° C.

If a temperature of the battery cells of the drive battery 2 increases above an upper threshold value of the optimum operating temperature range of e.g. 25° C., the temperature regulation control means 16 performs a cooling procedure, wherein the temperature regulating circuit 3 is switched from the bypass flow-through section 36 to the cooling flow-through section 34 by means of activation of the valves. The heat transfer medium which is cooled in the ambient heat exchanger 4 by the ambient air circulates through the battery flow-through section 32 and absorbs waste heat of the drive battery 2.

In the event of a further increase in the temperature of the drive battery 2 to a threshold value of e.g. 40° C., the temperature regulation control means 16 additionally performs a fan procedure. In this case, the temperature regulation control means 16 effects a control of the power supply to the electric fan 44. Feedback for regulating a duration or electrical power of the fan 44 can be effected in relation to temperature detection of a battery temperature sensor 21, the inlet temperature sensor 12 or the outlet temperature sensor 14. In contrast to the illustrated embodiment, a temperature sensor can likewise be provided for this purpose between the cooling flow-through section 34 and the battery flow-through section 32.

As an output variable of a regulation of the pumping power and a heating power, the temperature regulation control means 16 uses a temperature which is detected in the region of the drive battery 2 by means of the temperature sensor 21, or uses a temperature of the heat transfer medium which is detected within the temperature regulating circuit 3. A temperature sensor which is suitable for this purpose is provided in the present embodiment both by means of an inlet temperature sensor 12 in a pump inlet of the pump housing 11 and also by means of an outlet temperature sensor 14 in a pump outlet of the pump housing 11.

The temperature regulation control means 16 preferably controls specific operating points of the temperature regulating device 1 which constitute an optimization of the pumping power in relation to a hydraulic resistance of the pump geometry or an optimization of the heating power in relation to a transfer of heat from the heating means to the passing mass flow of the heat transfer medium. Such specific operating points of the temperature regulating device 1 can be activated either by pre-stored values in the temperature regulation control means 16 or in feedback with respect to a detected temperature difference between the inlet temperature sensor 12 and the outlet temperature sensor 14 as well as a pump rotational speed. Furthermore, feedback with respect to a regulation of a duration and an electrical power for the heating procedure can be effected in dependence upon temperature detection of the battery temperature sensor 21 or the inlet temperature sensor 12.

### LIST OF REFERENCE SIGNS

1 temperature regulating device
2 drive battery
3 temperature regulating circuit
4 ambient heat exchanger
10 temperature regulating system
11 pump housing
12 inlet temperature sensor
13 pump assembly
14 outlet temperature sensor
15 heating means
16 temperature regulation control means
17 interface
21 battery temperature sensor
32 battery flow-through section
34 cooling flow-through section
35 heating flow-through section
36 bypass flow-through section

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A temperature regulating device configured for regulating the temperature of a drive battery of an electric drive in a vehicle comprising;
a temperature regulating circuit having:
a battery flow-through section that is in thermal contact with the drive battery;
a cooling flow-through section that is in thermal contact with an ambient heat exchanger; and
piping sections for connecting the temperature regulating circuit and the temperature regulating device;
wherein
the temperature regulating device includes:
an electric pump assembly with a pump housing for circulating a liquid heat transfer medium;
electric heating means for heating the heat transfer medium; and
temperature regulation control means having:
a pump control section configured to control a pumping power; and
a heating control section configured to control a heating power; wherein
a heating flow-through section for the temperature regulating circuit, which is in thermal contact with the electric heating means, is arranged inside the pump housing.

2. The temperature regulating device according to claim 1, wherein
the temperature regulation control means is configured to control the pumping power and the heating power depending on at least one of a temperature of the drive battery detected by a battery temperature sensor and a temperature of the heat transfer medium detected inside the temperature regulating circuit.

3. The temperature regulating device according to claim 1, wherein
an inlet temperature sensor for detecting a temperature of the heat transfer medium inside a flowed-through section of the pump housing is arranged upstream of the heating means.

4. The temperature regulating device according to claim 1, wherein
an outlet temperature sensor for detecting a temperature of the heat transfer medium inside a flowed-through section of the pump housing is arranged downstream of the heating means.

5. The temperature regulating device according to claim 1, wherein
an electrical connector is arranged extending out of the pump housing, which provides a common interface for control sections of the temperature regulation control means to at least one of a central control unit (ZSE) of the vehicle and additional temperature sensors.

6. The temperature regulating device according to claim 1, wherein
the cooling flow-through section additionally comprises an electric fan for assisting the ambient heat exchanger, and the temperature regulation control means includes a cooling control section configured to control a fan power.

7. The temperature regulating device according to claim 1, wherein
the temperature regulating circuit additionally comprises a switchable bypass flow-through section for bypassing the cooling flow-through section, and the temperature regulation control means includes a bypass control section configured to switch the temperature regulating circuit between the cooling flow-through section) and the bypass flow-through section.

8. The temperature regulating device according to claim 1, wherein
the heating flow-through section is formed by a pump chamber of a centrifugal pump type.

9. A device in a temperature regulating system configured for regulating the temperature of a drive battery of an electric drive in a vehicle, comprising:
an electrically driven pump assembly with a pump housing for circulating a liquid heat transfer medium;
a temperature regulating circuit having:
a battery flow-through section that is in thermal contact with the drive battery;
a cooling flow-through section that is in thermal contact with an ambient heat exchanger;
a heating flow-through section that is in thermal contact with an electric heating means; and
piping sections for connection of the temperature regulating circuit and the pump assembly;
wherein
the pump housing of the pump assembly includes a temperature regulation control means having:
a pump control section configured to control a pumping power; and
a heating control section configured to control a heating power; and
the heating flow-through section of the temperature regulating circuit is arranged inside the pump housing.

10. The device in a temperature regulating system according to claim 9, wherein
the temperature regulation control means is configured to control the pumping power and the heating power depending on at least one of a temperature of the drive battery detected by a battery temperature sensor and a temperature of the heat transfer medium detected inside the temperature regulating circuit.

11. The device in a temperature regulating system according to claim 9, wherein
an inlet temperature sensor for detecting a temperature of the heat transfer medium inside a flowed-through section of the pump housing is arranged upstream of the heating means.

12. The device in a temperature regulating system according to claim 9, wherein
an outlet temperature sensor for detecting a temperature of the heat transfer medium inside a flowed-through section of the pump housing is arranged downstream of the heating means.

13. The device in a temperature regulating system according to claim 9, wherein
an electrical connector is arranged extending out of the pump housing, which provides a common interface for control sections of the temperature regulation control means to at least one of a central control unit (ZSE) of the vehicle and additional temperature sensors.

14. The device in a temperature regulating system according to claim 9, wherein
the cooling flow-through section additionally comprises an electric fan for assisting the ambient heat exchanger, and the temperature regulation control means includes a cooling control section configured to control a fan power.

15. The device in a temperature regulating system according to claim 9, wherein
the temperature regulating circuit additionally comprises a switchable bypass flow-through section for bypassing the cooling flow-through section, and the temperature regulation control means includes a bypass control section configured to switch the temperature regulating circuit between the cooling flow-through section and the bypass flow-through section.

16. The device in a temperature regulating system according to claim 9, wherein
the heating flow-through section is formed by a pump chamber of a centrifugal pump type.
